(19) United States
(12) Patent Application Publication
(10) Pub. No.: US 2007/0087308 A1
(43) Pub. Date: Apr. 19, 2007

(54) Medical, in particular dental-medical handpiece

(75) Inventors: Alexander Flock, Biberach (DE); Alexander Klee, Biberach (DE); Helmut Gruber, Buxheim (DE); Bernhard Lingenhoele, Warthausen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach (DE)

(21) Appl. No.: 11/399,278

(22) Filed: Apr. 6, 2006

(30) Foreign Application Priority Data
Apr. 7, 2005 (DE) 10 2005 016 036.0
Jun. 13, 2005 (DE) 10 2005 027 263.0

(51) Int. Cl. A61C 1/05

(52) U.S. Cl. 433/132

(57) ABSTRACT

The invention relates to a medical handpiece, in the forward end region of which a tool can be put in place, having a mounting sleeve for receiving the tool, having a carrier sleeve, in which the mounting sleeve is arranged, having a drive element standing in driving connection with the carrier sleeve, having inner bearing elements likewise arranged on the carrier sleeve, having outer bearing elements, and having roller bodies located between the inner bearing elements and the outer bearing elements. In order, in the event of repair, to be able to exchange only a bearing unit carried by the carrier sleeve or a mounting unit including the carrier sleeve and the mounting sleeve, the inner bearing elements are formed of a one-piece inner bearing sleeve which is releasably attached to the carrier sleeve and carries the drive element.

The invention relates to a medical, in particular dental-medical handpiece in accordance with the preamble of claim 1.

Handpieces of the kind considered here generate—in particular when turbine handpieces are involved—speeds of rotation for the tool of up to 400,000 min⁻¹ and with newer constructions also up to 500,000 min⁻¹ (revolutions per minute). With such speeds of rotation, the bearings can develop undesired noises, if the bearing grooves in the inner bearing elements and the outer bearing elements are not exactly adjusted to one another or the rotating elements are not balanced. The above-mentioned defects also lead, in operation of the handpiece, to premature wear, which is undesired.

In the case of a known dental turbine handpiece (U.S. Pat. No. 3,376,084 McKee) there is provided a continuous carrier sleeve into which a mounting sleeve is screwed. On the outer side of the carrier sleeve there is located in its middle region a turbine rotor, which is fixed on a carrier sleeve. To both sides of the turbine rotor, the carrier sleeve has running grooves for the balls of two ball bearings. The balls are held at a spacing by means of ball cages and on the outside run in two outer rings arranged to the two sides of the turbine rotor, which are provided at their inner sides with corresponding running grooves. The outer rings are fixedly arranged in the housing of the turbine head and are so held and positioned at a spacing in the axial direction, by means of a thin sleeve, that the inner and outer running rings lie exactly opposite one another and through this disturbing bearing noises, in particular at high speed, can be avoided.

With a further known dental turbine handpiece (U.S. Pat. No. 5,040,980 Heil) the inner running rings for the ball bearings are located at the outer sides of two separate outer bearing rings, which—just as is the turbine rotor—are inserted onto the carrier sleeve and there fixed. Here also, there is located within the carrier sleeve—directly bearing on this—a mounting sleeve. The two bearing inner rings taper at their outer sides towards the axial ends, in order to facilitate the installation of the ball arrangements, normally seated in cages.

A further known dental turbine handpiece (U.S. Pat. No. 5,571,013 Novak) differs from the known turbine handpiece of McKee in that the carrier sleeve externally develops conically to both ends and differs with respect to the known turbine handpiece of Heil in that the carrier sleeve and the inner bearing rings, and a part lying therebetween (onto which the turbine rotor is pushed) are formed in one piece.

All handpieces of the kind considered here have in common that the drive element, in particular when a rapidly rotating turbine rotor is involved, must be balanced before the handpiece is put to use, in order to ensure that they run well and to avoid disturbing noises. This balancing is a procedure which is demanding in terms of time and, with regard to the small dimensions of the elements, is linked with precision work, which is best carried out by the manufacturing company.

Whilst the drive element (in particular, when this is a turbine motor) is in operation of the handpiece practically not subject to wear, this does not apply for the bearing elements and for the mounting sleeve. The latter must, inter alia over the working live of the handpiece, be exchanged. The repair work correspondingly involved should thereby be carried out in as short a time as possible. In the case of the previously known handpieces, with this requirement, only the compete unit of carrier sleeve, drive element (e.g. turbine wheel) bearing elements and mounting sleeve can be exchanged.

The object of the invention is to indicate a construction for a handpiece of the kind considered here which permits, in the case of repair, both the bearing unit alone, and also the mounting system alone, to be exchanged.

The solution according to the invention consists in that the inner bearing elements are formed by means of a one-piece inner bearing sleeve, which is releasably attached to the carrier sleeve and carries the drive element.

Repair of the handpiece in accordance with the invention is effected as follows. Here also initially the entirety of carrier sleeve, inner bearing sleeve, drive element (e.g. turbine rotor) and mounting sleeve, is removed from the housing head of the handpiece. Then, the inner bearing sleeve with the drive element on the one hand, and the carrier sleeve with the bearing sleeve located therein on the other hand, are separated from one another. In this way there arise two sub-units, on the one hand the bearing unit and on the other hand the mounting unit. The damaged sub-unit is exchanged for a new sub-unit from store. Then, the two sub-units are again assembled together and installed in the handpiece. In no case is a renewed balancing necessary in repair operations. If the inner bearing sleeve with the drive element located thereon must be exchanged, the bearing unit available for exchange is already balanced, i.e. it is made available or delivered by the manufacturing company in a balanced condition. This applies also to the sub-unit of the carrier sleeve and the mounting sleeve.

From the same point of view it is advantageous that a mounting sleeve, representing a part subject to wear, is not alone available for exchange, but only in connection with the carrier sleeve into which it is installed. The mounting sleeve is, due to the slits and, if applicable also due to its outer conical form, not a rotationally symmetric part. Its installation on site would thus likewise lead to a need that at the location of the repair renewed balancing must take place. This necessity does not arise because the carrier sleeve represents a rotationally symmetric part fitting exactly into the inner bearing sleeve, which as bearing unit together with the mounting sleeve can be pre-balanced by the manufacturing company.

The one-piece inner bearing sleeve employed in the handpiece in accordance with the invention has further the advantage of ball runs precisely cut with respect to one another. Further there are present, between the inner bearing sleeve and the drive element, matching surfaces, which make possible an exact positioning of the drive element. It is thus possible to position a balanced drive element on the inner bearing sleeve without expectation of a significant imbalance. It is, however, also possible to pre-balance the inner bearing sleeve and the drive element mounted thereon, and to make this available as a sub-unit for repair.

The necessary fixing of the one-piece inner bearing sleeve on the carrier sleeve is effected for example by means of an adhesive connection or by means of a longitudinal press-fit connection.

A further advantageous configuration of the handpiece in accordance with the invention may consist in that the outer sides of the two end regions of the one-piece inner bearing sleeve develop conically towards the end, in order to facilitate the mounting of the ball cages loaded with balls. In order to axially fix the ball rings on the one-piece inner bearing sleeve, the inner bearing sleeve may be provided with running grooves, wherein each running groove forms with correspondingly conical end region a radial elevation, which hinders a sliding away of the ball rings. The mentioned elevation should have a diameter which—seen in section through the inner bearing sleeve—is greater than the diameter at the groove base.

A further possibility for facilitating the mounting of ball rings, formed of cages with balls, on the inner bearing sleeve may consist in that the outer bearing rings are conically expanded at the corresponding inward end regions towards the end of the inner bearing sleeve. Here also there lies between the conical region and a correspondingly provided running groove a slight elevation, which hinders a sliding out of the ball ring out of the running groove in axial direction. Thereby, the diameter of the elevation should be lesser than the diameter at the groove base.

Whilst the unit consisting of the roller bodies and the associated cage is, upon mounting on the inner bearing sleeve by means of displacement in the axial direction, enlarged in the first-mentioned case, in the second-mentioned case it is reduced.

The conical sections provided at the outer side of the inner bearing sleeve or at the inner side of the inner bearing rings may rise linearly or also may be formed of a hollow channel.

Below, the invention and further advantages which can be achieved thereby will be explained in more detail with reference to advantageous configurations of a preferred example.

There is shown:

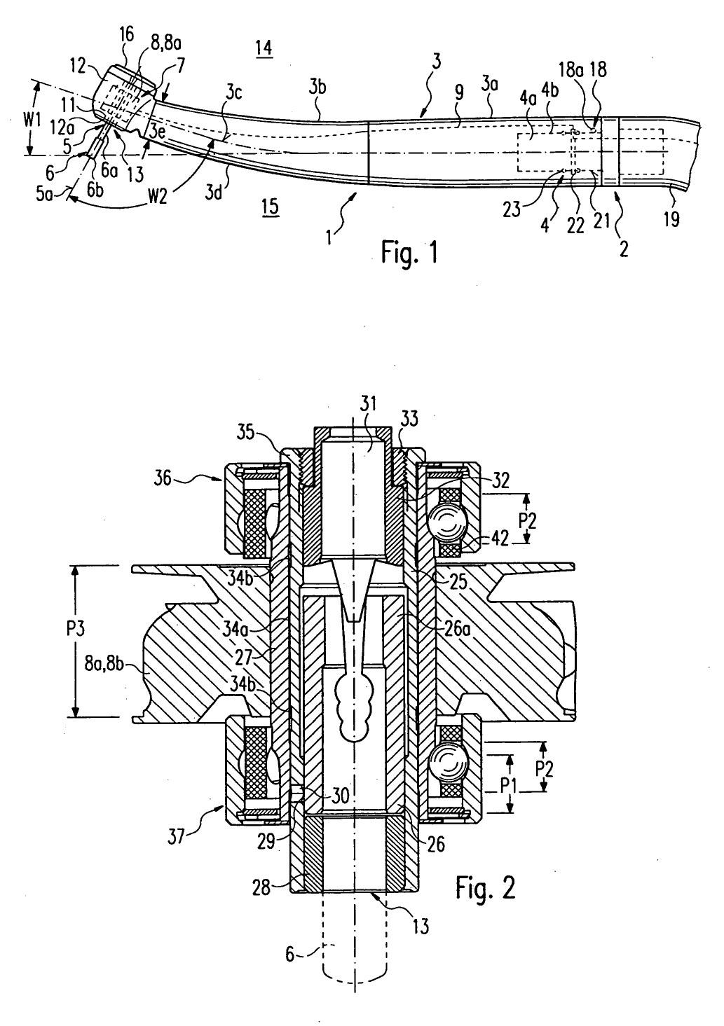

FIG. 1 a dental-medical treatment instrument in accordance with the invention, with a handpiece, in a side view;

FIG. 2 a rotary bearing arrangement, arranged in the handpiece head of the handpiece, for a receiving sleeve for receiving the tool, in axial section, and in a representation to an enlarged scale;

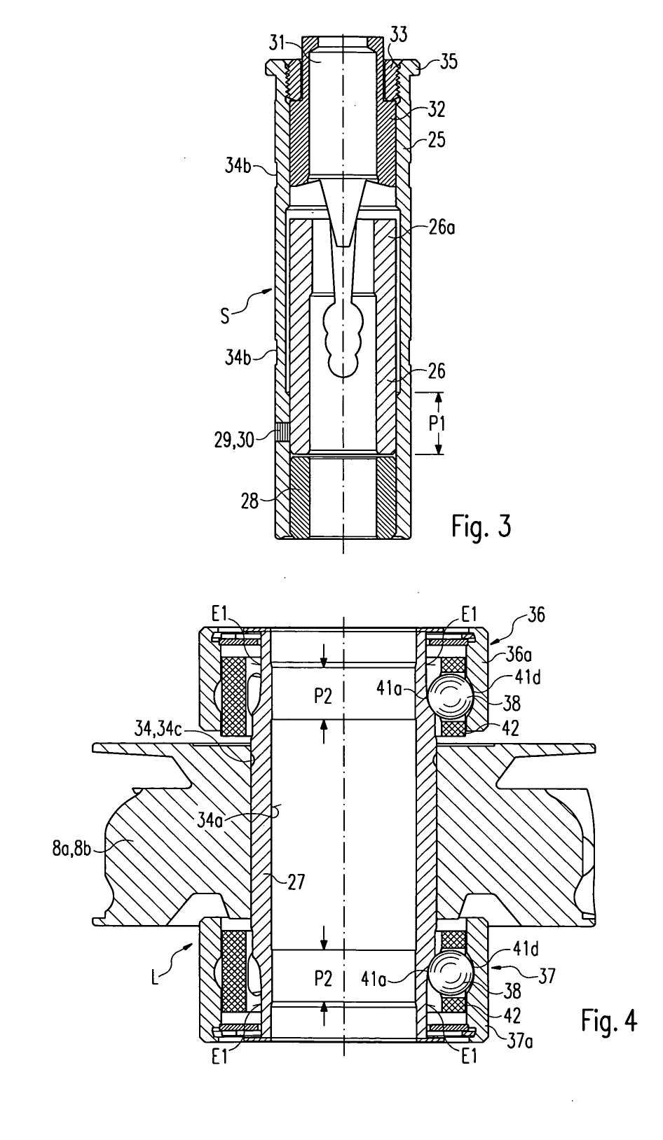

FIG. 3 a first sub-unit in the form of a mounting unit of the receiving sleeve, in axial section;

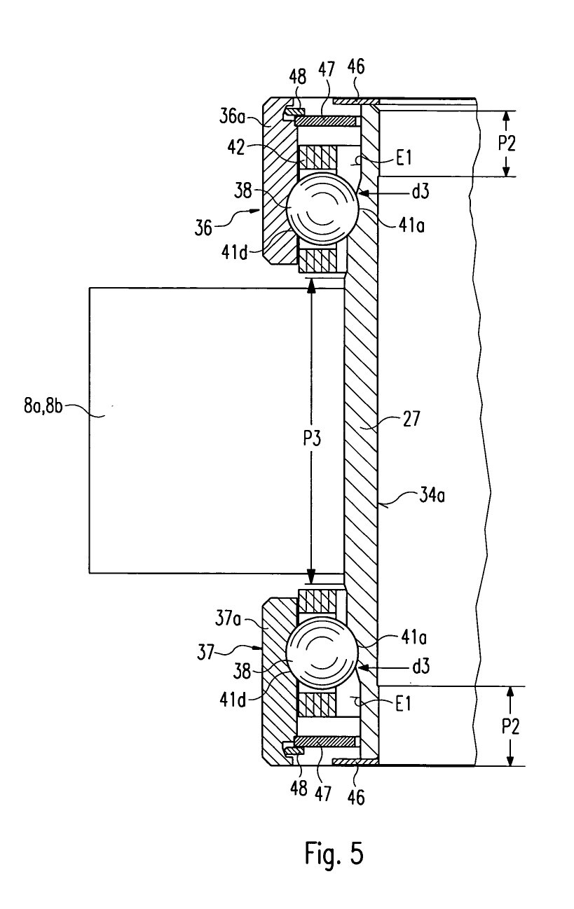

FIG. 4 a second sub-unit in the form of a bearing unit of the receiving sleeve, in axial section;

FIG. 5 a part of a bearing unit with an inner bearing sleeve, in axial partial section and to somewhat enlarged scale;

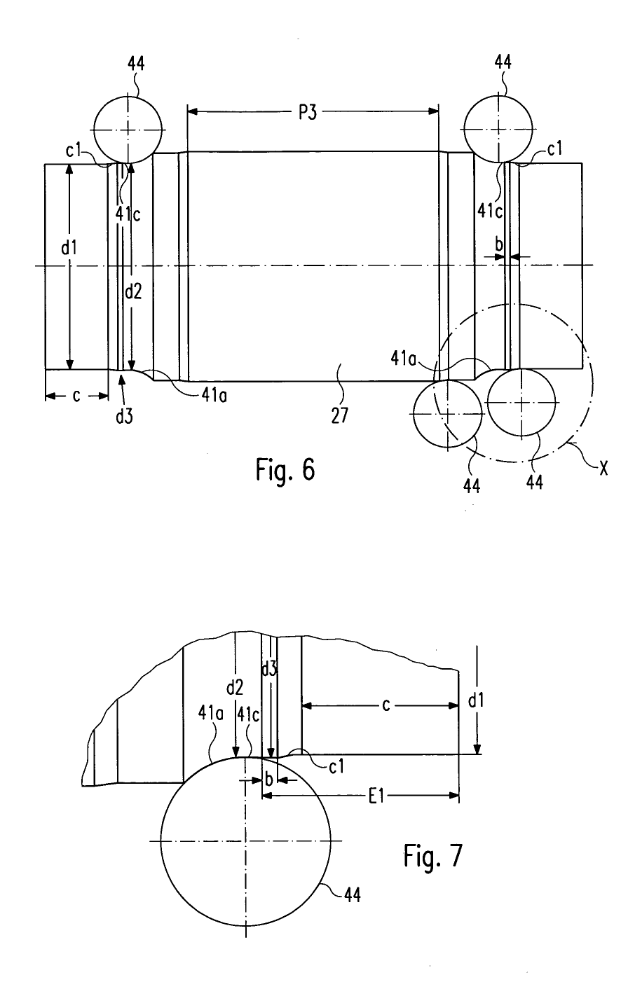

FIG. 6 the inner bearing sleeve according to FIG. 5, in a side view;

FIG. 7 a detail designated by X in FIG. 6, in a representation to an enlarged scale;

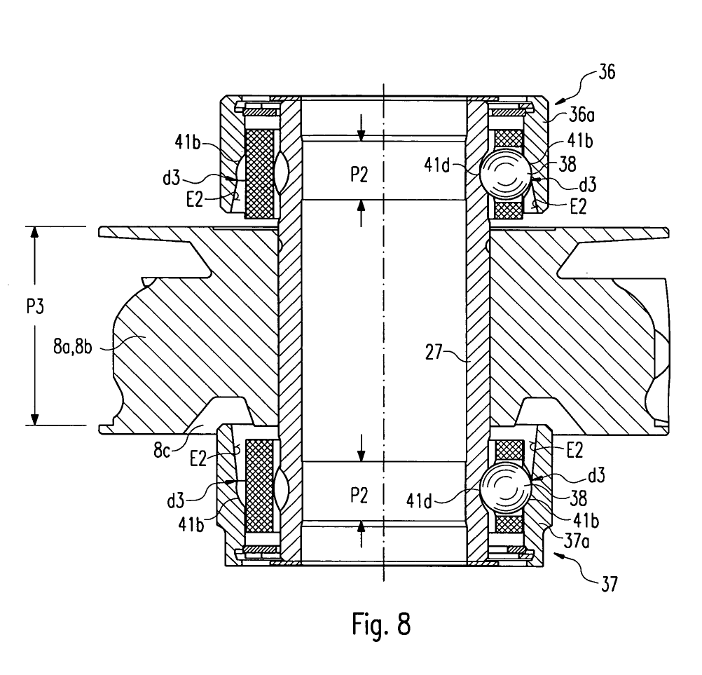

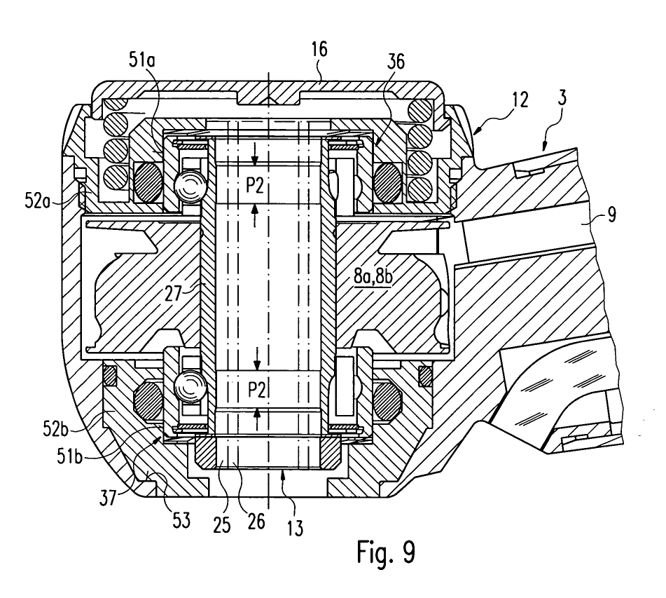

FIG. 8 a bearing unit in axial section, in a modified configuration;

FIG. 9 a handpiece head in axial section, in a modified configuration;

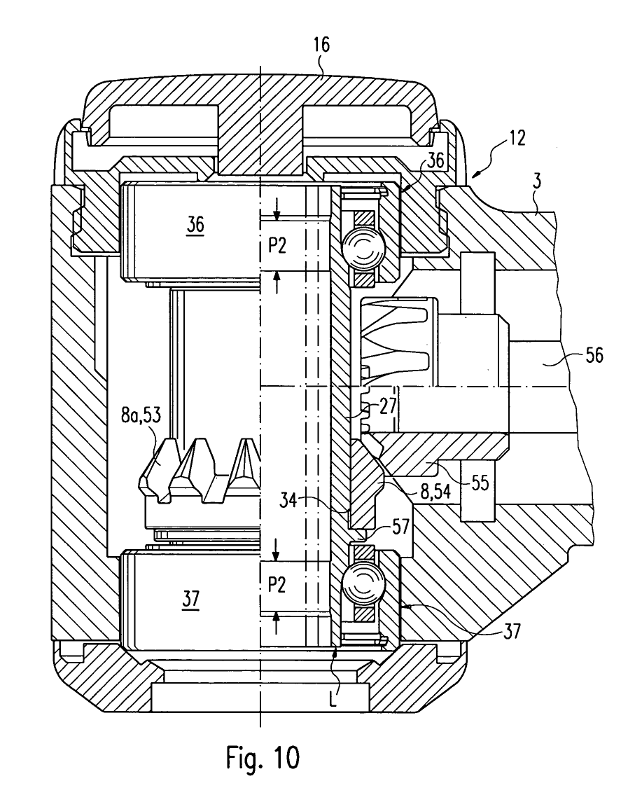

FIG. 10 a handpiece head in axial section, in a further modified configuration;

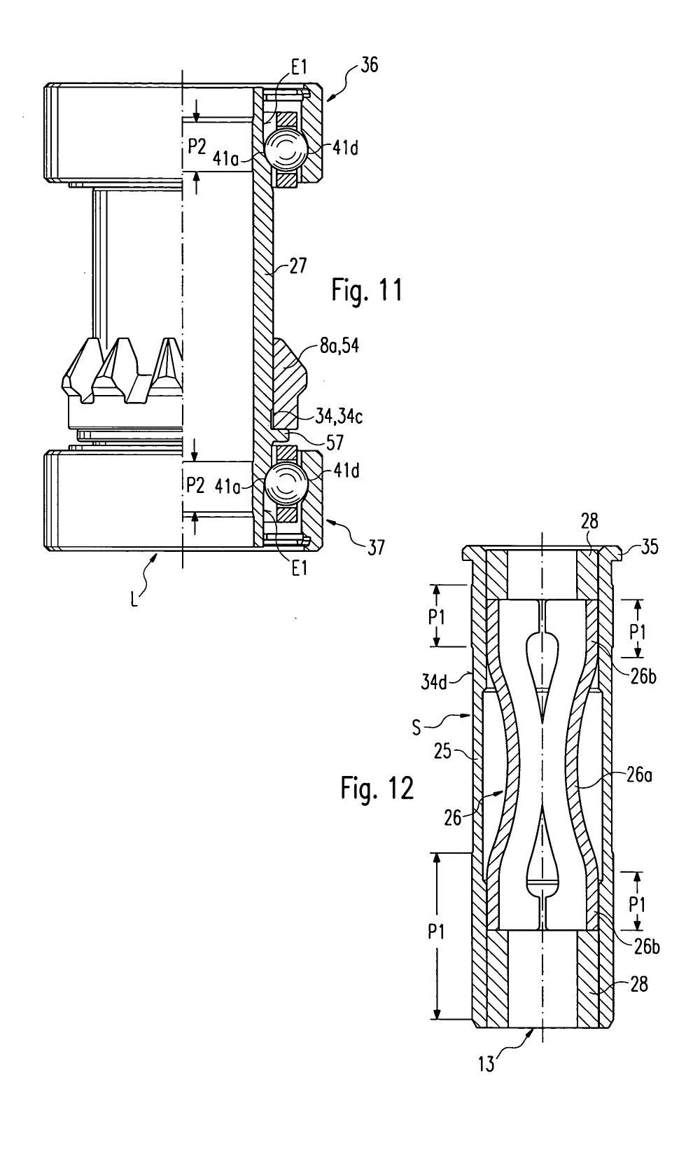

FIG. 11 a bearing unit of the handpiece head according to FIG. 10, in axial partial section;

FIG. 12 a first sub-unit in the form of a mounting unit of the receiving sleeve, in axial section and in a modified configuration.

The main parts of the treatment instrument, generally designated by 1, are a connection part 2 forming the rearward end of the treatment instrument 1, the handpiece 3, which is releasably connected with the connection part 2 by means of a quick coupling 4 in the form of a plug-in coupling, in particular a plug-in/turn coupling, and in the coupled condition extends forwardly from the connection part 2 in the form of a rod-like grip part, a holder device 5, arranged in the forward end region of the handpiece 3, for a treatment or working tool 6, and a drive motor 7, which may be arranged in the region of the connection part 2 or in the region of the handpiece 3 and in the case of the present exemplary embodiment is formed by means of a turbine 8 integrated in the forward end region of the handpiece 3, as is per se known in the case of a so-called turbine handpieces.

If the drive motor 7 is located in the connection part 2 (not illustrated), a drive shaft is rotatably mounted in the handpiece 3, which in the condition of the handpiece 3 coupled with the connection part 2 stands in driving connection with the drive motor by means of a plug-in coupling, and which upon removal of the handpiece 3 from the connection part 2 is self-actingly released. The forward end of the drive shaft is drivingly connected with a receiving sleeve 11, in which the working tool 6 can be inserted, fixed for rotation and axially positioned. For the rotary drive of the receiving sleeve 111 there is arranged thereon a drive element 8a which in the case of a drive shaft is formed by means of a pinion gear and in the case of a turbine 8 by means of a turbine wheel 8b.

In the case of the present exemplary embodiment, in which a turbine 8 is provided, there extends through the treatment instrument 1 a compressed air line 9 to the turbine 8 and, if applicable, also a non-illustrated discharge line for used compressed air, which will be described below. The holder device 5 is formed by means of the receiving sleeve 11 on which the turbine wheel of the turbine 8 sits and is rotatably mounted in the preferably thickened handpiece head 12 of the handpiece 2. The receiving sleeve 11 is open at its one end, through which an insertion opening 13 for a shaft 6a of the working tool 6 is formed, the working section of which tool, abrasive or provided with cutting edges, is designated by 6b. The forward grip part section having the handpiece head 12 is angled towards a side 14 of the handpiece 3, whereby the acute angle W1 in the angled region lies between 10° and 28°, preferably being about 19°. The working tool 6 can be inserted into the receiving sleeve 11 from the opposite side 15 of the handpiece 3, whereby upon insertion the tool is self-actingly rotationally fixedly connected with the receiving sleeve 11 and positioned therein axially against an unintended removal. For releasing the working tool 6 there may be provided an actuating element 16 on the side 14 of the handpiece head 12 opposite to the insertion opening 13, upon the manual displacement of which actuating element with respect to the handpiece 12 the axial positioning of the receiving sleeve 11 is released, so that the tool 6 can be drawn out axially to the side 15.

The angle W2 included between the longitudinal middle axis 3c of the handpiece 3 and the longitudinal middle axis 5a of the holder device 5 may be a right angle or an obtuse angle, which is 95° to 110°, in particular about 100° to 105°.

By means of the quick coupling 4, the handling of the handpiece 3 is substantially improved, because the connection part 2 does not need to participate in rotational movements of the handpiece 3 during the treatment or working, and thus a rotational compensation can take place. The plug-in/turn coupling has a hollow cylindrical coupling pin 4a on the one coupling part and a coupling recess 4b, receiving the coupling pin 4a with slight play for movement. In the case of the present configuration, the coupling pin 4a extends forwardly from the connection part 2 and the coupling recess 4b is arranged in the rearward end region of the handpiece 3. For releasable positioning of the plug-in coupling in the coupling disposition, there serves a latch device 18, which can be manually overcome, having a transversely moveably mounted latch element 18a, which is arranged in a recess of the outer envelope surface of the plug-in pin 4a or in the inner envelope surface of the plug-in recess 4b and by means of an elastic spring force is so pressed into a latch recess arranged in the respective opposite other part, that a latching element 18a can spring out and the latch device 18 can be overcome by means of an axially directed and readily manually applicable pulling force.

The connection part 2 is connected with a non-illustrated control apparatus, by means of a schematically illustrated supply line 19, in particular by means of a flexible supply hose, connected with the coupling part 2, as is per se known in the case of a medical or dental-medical treatment station. The compressed air line 9 extends through the supply line 19 and through the treatment instrument 1 and there can also extend at least one further medium line, e.g. for light, air, water and/or spray, which extends through the plug-in turn coupling 4 such that passage through the medium line or lines is ensured in any rotational position. The at least one medium line 9 can pass through the dividing joint 21 between the plug-in pin 4a and the plug-in recess 4b in a Z-form in a ring groove, wherein the section of the medium line 9 passing radially through the dividing joint 21 is sealed off by means of sealing rings 23 arranged to both sides of the ring groove 22, which sealing rings are arranged in an outer ring groove of the plug-in pin 4a or in an inner ring groove of the plug-in recess 4b.

The receiving sleeve 11 is of a plurality of parts arranged radially on one another and arranged coaxially, namely a middle carrier sleeve 22, a mounting sleeve 26 arranged therein, and an inner bearing sleeve 27 arranged on the carrier sleeve 25. These parts sit with cylindrical or hollow cylindrical matching surfaces on one another. The mounting sleeve 21 is axially inserted into the carrier sleeve 25, preferably from that end at which the insertion opening 13 for the indicated tool 6 is located, which in the arrangement illustrated in the Figures is arranged below in an intermediate sleeve 28, which is arranged and fixed below the mounting sleeve 26 in the carrier sleeve 25. The mounting sleeve 26 is in the case of this exemplary embodiment only in its lower region arranged and fixed with cylindrical matching surfaces P1 in a matching manner in the carrier sleeve 25, e.g. fixed by means of a weld point 29 connecting the mounting sleeve 26 with the carrier sleeve 25, which in the region of a radial hole 30 in the carrier sleeve 25 is prepared from the outside, in particular a laser welding. A plurality of welding points 29 may be arranged distributed in holes 30 on the circumference. The upper longitudinal region of the mounting sleeve 26 is formed by means of mounting segments 26a, which have a radial spacing from the inner envelope surface of the carrier sleeve 25 and for the release of a tool 6 inserted between the mounting segments 26a can be spread apart by means of a releasing wedge 31, arranged in the upper region, for release of the tool, when the releasing wedge 21 is displaced downwardly by means of a manual exercise of pressure on the actuating element 16. The wedge returns self-actingly into its upwardly displaced release position.

The releasing wedge 31 is coaxially displaceably mounted in a bearing sleeve 32, which sits above the mounting sleeve 26 in the carrier sleeve 25 and e.g. is screwed by means of a ring nut 33, which sits in a ring recess of the bearing sleeve 32 and with its outer threading is screwed into the carrier sleeve 25.

The inner bearing sleeve 27 sits on the carrier sleeve 25, and for its fixing is releasably connected by means of a press-fit connection with the carrier sleeve 25, or releasable adhered thereto. Thereby, the inner bearing sleeve 27 and the carrier sleeve 25 sit radially on one another with matching surfaces P2, which are located in the axial end regions of these parts and in the inner bearing sleeve 27 are emphasized with matching surfaces P2. Through this, the inner bearing sleeve 27 and the carrier sleeve 25 receive an exact and stable coaxial positioning with respect to one another.

Between the carrier sleeve 25 and the inner bearing sleeve 27 there may be arranged one or more ring gaps 34, in which an adhesive for an adhesive connection is located. The at least one ring gap 34 is advantageous because in the absence of the ring gap 34 an applied adhesive could be displaced away upon coaxial assembly of these parts. In the case of the exemplary embodiment, a ring groove 34a is arranged in the inner bearing sleeve 27 between the matching surfaces P1, which ring groove extends over the width of the drive element 8a, here a turbine wheel 8b. There may also be arranged one or more ring grooves 34b only or additionally in the outer envelope surface of the carrier sleeve 25 which ring grooves provide one or more ring gaps for the adhesive. In the case of the exemplary embodiment the ring gap or gaps 34b are located in the carrier sleeve 25, in the installation position in the region of the axially relatively long ring groove 34a, so that an adhesive setting in the ring grooves 34a, 34b brings about an axial securing of these parts with respect to one another not only due to its adhesion, but also in a form-fitting manner.

In the case of the present exemplary embodiment, the carrier sleeve 25 has at its end away from the insertion opening 13, here at its upper end, a flange 35, which forms a direct or indirect axial boundary for the inner bearing sleeve 27, which in this case is inserted from below onto the carrier sleeve 25, or the carrier sleeve 25 is inserted from above into the inner bearing sleeve 27.

On the inner bearing sleeve 27 there sits in a middle longitudinal region the drive element 8a, here the turbine wheel 8b, in the region of a matching surface section P3, whereby also the drive element 8a may be connected with the inner bearing sleeve 27 by means of a releasable or non-releasable press-fit connection or by means of a releasable or non-releasable adhesive connection. In the latter connection case there is also arranged between the inner envelope surface of the drive element 8a and the outer envelope surface of the inner bearing sleeve 27 at least one ring gap for the adhesive, which e.g. may be formed by means of an outer ring groove 34c in the outer envelope surface of the inner bearing sleeve 27. In the region of its matching surface P3, the inner bearing sleeve 27 is formed in cross-section somewhat larger than in its axially neighboring regions. Upon pushing on of the drive element 8a there is thus effected a slide loading only in the region of the matching surfaces P3.

The first sub-unit, designated in its entirety as a mounting unit S, and the second sub-unit, designated in its entirety as bearing unit L, of the receiving sleeve 11 are pre-fabricated parts, which are exactly matchingly installed and e.g. prior to this installation in each case individually balanced or after this installation are balanced in common and made available, which in particular in the case of high speed handpieces, in particular turbine handpieces, is important.

In the case of a repair exchange of the mounting unit S or of the bearing unit L only one of these units thus needs to be exchanged. For this purpose, the receiving sleeve 11 is disassembled into the two units, and the unit requiring repair replaced and installed.

In particular with regard to the bearing unit L it is to be remarked that in this case due to the favorable arrangement and position of the matching surfaces P2 after the assembly of these units L, S a common balancing is not necessary. They may, however, within the scope of the invention, be balanced in common.

In the case of the mounting unit S it is, in contrast, due to the one-sided holding of the mounting sleeve 26 in the region of the matching surfaces P1, advantageous to balance this unit S in common, i.e. with carrier sleeve 25 and a mounting sleeve 26, through which there is provided an exactly balanced mounting unit S.

Thus, in the case of repair, no balancing is needed. In the case of an exchange of the mounting unit S resort can be made to an exactly balanced unit S, and upon exchange of a bearing unit L no balancing is needed.

The receiving sleeve 11 is rotatably mounted in the handpiece head 12 by means of two roller bearings 36, 37 arranged to the two sides, namely above and below, the drive element 8a. The outer rings 36a, 37a of the roller bearings 36, 37 sit radially and axially positioned in a bearing bore, not illustrated in FIG. 1, in the handpiece head 12. For the roller bodies 38 of the roller bearings there are matchingly arranged outer bearing elements and inner bearing elements in the form of outer and inner running grooves 41a, 41b in the outer rings 36a, 37a and in the inner bearing sleeve 27. The bearing sleeve 27 thus forms a one-piece common inner bearing sleeve for both roller bearings 36, 37 extending axially over both roller bearings 36, 37. The running grooves 41a in the outer envelope surface of the inner bearing sleeve 27 are axially bounded inwardly by means of the curved running groove shoulder surfaces, and axially outwardly open, so that the roller bearings 38, positioned in a cage 42 and preferably of ceramic material, can be pushed onto the inner bearing sleeve 27 as a ring from the outside, and installed. The envelope surface section of the inner bearings sleeve 27, lying outwardly with respect to the running groove 41a, is formed as a lead-in surface E1, which guides the roller bodies 38a self-actingly into the associated running groove 41a upon axial pushing on.

In order to facilitate the axial pushing on, in each case the longitudinal section c of the lead-in surface E1, lying outwardly with respect to the running groove 41a, is in each case somewhat smaller in diameter d1 than the diameter d2 of the running groove 41a.

Preferably, however, there may be arranged outwardly neighboring the running groove 41a a small radial elevation d3, e.g. a ring beading 43, on the inner bearing sleeve 17, which is radially only so large that upon pushing on of the roller bodies 38 it exercises with the associated outer ring and the cage 42 a clamping effect and thus an axial resistance on the roller bodies 38, which can be overcome by means of a manual axial pressure upon pushing on. Through this, the bearing body unit of the roller bodies 38, the cage 42 and the associated outer ring, receives an axial securing against an unintended removal from the inner bearing sleeve 27. Through this, the bearing body unit is held in the associated running groove 41a, such that it cannot be lost. In the case of an intended removal of this bearing body unit, it can naturally be overcome by means of a manual exercise of force upon pushing down. By means of the above-described axial resistance of the elevation d3 there is thus created a barrier which can be overcome by a manual exercise of force.

In the other end region of the inner bearing sleeve 27 there is formed such an axial securing for each bearing body unit of the other roller bearing, which is formed in a mirror image manner with reference to a middle transverse plane.

As FIGS. 6 and 7 show, the elevation d3 is formed upon cutting of the running grooves 41 and the longitudinal section c in that the cutting body 44, the size and form of which correspond to the size and form of the roller bodies 38, is not moved axially with respect to the associated end of the inner bearing sleeve 27, but is moved radially outwardly, through which there is provided a running groove section 41c divergent towards the associated sleeve end.

On the other hand, upon axial advancing upon cutting of the longitudinal section c, the cutting body 44 is only so far pushed towards the associated running groove 41a that an arc section c1 divergent towards the running groove 41a ends at or in a small axial spacing from running groove section 41c.

The above-described lead-in surface E1 is thus formed step-like, in particular in relation to the diameters d1 and d2. Within the scope of invention, the lead-in surface E1 may be formed outwardly convergently, conically shaped, and thus with a continuous upward inclination, whereby such a conical surface runs out in the diameter d2 of 41a or in the diameter d3 of the radial elevation.

Alternatively, the roller bearings 36, 37 may be so formed that the lead-in surfaces designated here by E2 are formed not at the outer envelope surface of the inner bearing sleeve 27, but at the inner envelope surface of the outer rings 36a, 37a, which is illustrated in FIG. 8.

With this configuration, the running grooves 41b are inwardly so configured that the roller bodies 38 can be axially introduced into the running grooves 41b. With this configuration, the running grooves 41b are however, open in the other axial direction, namely open inwardly from the associated end of the inner bearing sleeve 27. With this configuration, initially the roller bodies 38 with the cage 42 are arranged in the running groove 41d, closed to both sides, in the inner bearing sleeve 27, and then the outer ring 36a or 37a is in each case pushed on from the respective associated end of the inner bearing sleeve 27.

In order thereby initially to ensure a ready displacement of the associated outer ring 36a, 37a, the lead-in surfaces E2 are, with reference to the outer ring 36a, 37a, conically outwardly divergent and with reference to the radially opposite running groove 41a, divergent towards the middle of the inner bearing sleeve 27.

Within the scope of the invention, the lead-in surfaces E2 may in principle be formed as are the lead-in surfaces E1, namely cylindrically step-formed divergent, or the lead-in surfaces E1 may be formed conically divergent.

Also in accordance with FIG. 8 there may be present a radial elevation d3 of the lead-in surface E2, which however is formed not by means of an enlargement of the cross-section dimension, but by means of a reduction of the cross-sectional dimension, but has the same function in the sense of an axially surmountable resistance upon pushing on of the roller bodies 38 positioned by means of the cage 42. Thereby, there can also be correspondingly cut in the lead-in surfaces E2 the divergent running groove section 41c and arc section c1.

In both above-described cases, a radial elevation d3 leads to an increase of the running surface of the running grooves 41a, 41b and thus to an extension of the working life of the roller bearings 36, 37.

In the case in which at least one running groove 41a at the inner bearing sleeve 27 is axially open, the radially oppositely lying running groove at the associated outer ring 36a, 37a is a conventional running groove 41d, which is closed at both sides. This applies also for the alternative configuration in which the running groove 41b is open at one side in at least one outer ring 36a, 37a. In this case, the radially oppositely lying running groove at the inner bearing sleeve 27 is a conventional groove 41d, which is axially closed at both sides.

In the case of the above-described exemplary embodiments, the roller bearings 36, 37 have in the region of their outer sides away from one another in each case two blocking rings 46, 47, which are arranged overlapping one another in radial direction, wherein the one blocking ring 46 is fixed to the inner bearing sleeve 27 and the other blocking ring 47 is fixed to the associated outer ring 36a, 37a, as can be best understood from FIG. 5. The blocking rings 46, 47 form a barrier against contaminants and thus constitute a protection device. In the case of the exemplary embodiment, the inner blocking ring 46 is attached to the associated end face of the inner bearing sleeve 27, e.g. by means of point welding or adhesive connection. The outer blocking ring 47 is arranged on the inner side of the inner blocking ring, whereby it sits in a ring groove in the inner envelope surface of the outer ring 36a, 37a, and is secured by means of a spring ring 48 emplaced in the same or a parallel inner groove.

The blocking rings 46, 47 need not be present. If they are present, as is the case with the exemplary embodiment, they can be mounted after the installation of the roller bearings 36, 37. If the inner blocking ring 46 is non-releasably attached, it can be attached after the installation of the roller bearings 36, 37. Before a disassembly, at least the inner blocking ring 46 is to be removed.

In the case of all above-described exemplary embodiments, one of the two outer rings, here the outer ring 37a, may be arranged with respect to the drive element 8a slightly axially overlapping. In order to make this possible, there is arranged in the drive element 8a, in the region of the outer ring 37a, a ring groove 8c in the region of which the roller bearing ring 37a can slightly overlap the drive element 8a.

In the case of the exemplary embodiment according to FIG. 9, the roller bearings 36, 37 are emplaced in bearing bores 51a, 51b in bearing inserts 52a, 52b, wherein the two bearing inserts 52a, 52b are put in place from the side of the handpiece head away from the insertion opening 13. The bearing insert 52b arranged towards the insertion opening 13 is, in its cross-sectional size, smaller than the bearing insert 52a arranged away from the insertion opening 13, whereby the latter is screwed into the handpiece head, whilst the bearing insert 52b is emplaced from above into a bearing recess bounded below by means of a shoulder surface 53. In the upper bearing insert 52a there is mounted an axially insertable cover which forms an actuating element 16, with which a tool 6 can be displaced out of the only schematically illustrated mounting sleeve 26, which sits in a schematically illustrated carrier sleeve 25.

In the case of the exemplary embodiment according to FIGS. 10 and 11, in which the same or similar parts are likewise provided with the same reference signs, there is arranged a handpiece head 12 with a bearing unit L in the case of which the drive element 8a is formed by means of a pinion gear 54, which engages with a pinion gear 55 at the forward end of a drive shaft 56 rotatably mounted in the handpiece and extending from the rear forwardly. This drive element 8a or pinion gear 54 can likewise be attached to the inner bearing sleeve 27 by means of a press-fit connection or an adhesive connection. Here also there may be provided a gap 34 between the outer envelope surface of the inner bearing sleeve 27 and the inner envelope surface of the pinion gear 54 for receiving the adhesive, which e.g. may be formed by means of a ring groove 34c in the inner bearing sleeve 27. For additional axial support, this inner bearing sleeve 27 may have a ring shoulder 57 on which the pinion gear 54, formed as a conical toothed gear, bears with its side away from the teeth.

FIG. 12 shows a mounting unit S having a mounting sleeve 26 which has matching surfaces P1 not only in one but in both end regions, with which it is exactly positioned in the region of both ends, in the associated carrier sleeve 25.

In the case of this mounting sleeve 26 there are provided in its middle longitudinal region a plurality of mounting segments 26a arranged uniformly distributed on the circumference, which at both axial ends are connected in one piece with hollow cylindrical or segment-shaped end sections 26b, which in the longitudinal region are radially centered and axially fixed in the carrier sleeve 25 by the matching surfaces P1. The latter is effected by means of two intermediate sleeves 28 put in place at the ends in the carrier sleeve and axially fixed. With this configuration no device for ejection of the tool 6 is provided. The tool can be put in place and again removed by means of manual displacement.

With this configuration, the mounting sleeve 26 is sufficiently exactly centered in the carrier sleeve 35 and non-releasably fixed therein or releasably fixed in the carrier sleeve 35 with one or both intermediate sleeves 28, whereby the carrier sleeve 35 and the mounting sleeve 26 are pre-fabricated as prefabricated mounting unit S before an assembly with the inner bearing sleeve 27. Thereby, the carrier sleeve 35 and the mounting sleeve 67 can be balanced before the pre-fabrication or after the pre-fabrication can be balanced in common to a mounting unit S. Also with this exemplary embodiment there is thus not necessary a balancing upon an exchange of the mounting unit S.

In the case of this, and also the other, exemplary embodiments, the mounting sleeve 26 can be connected with the associated carrier sleeve 25 by means of a press-fit connection or by means of an adhesive connection. In the latter case there is provided also here at least one ring gap for the adhesive between the surfaces bearing on one another. There may be provided e.g. a small ring groove 34d for the adhesive between the matching surfaces P3, the cross-sectional dimension of which ring groove is only few tenths of a millimeter, in order to weaken as little as possible the cross-sectional size of the mounting sleeve 26. The latter applies for all exemplary embodiments.

For a releasable adhesive device there is suitable an adhesive which upon release of the adhered components is destroyed, e.g. sheared off, or which through the effect of heating looses its firmness.

1. A medical, in particular dental-medical, handpiece, comprising:
a forward end region;
a carrier sleeve in the forward end region;
a mounting sleeve arranged in the carrier sleeve for receiving a tool;
a drive element in driving connection with the carrier sleeve;
a plurality of inner bearing elements arranged on the carrier sleeve;
a plurality of outer bearing elements; and
a plurality of roller bodies located between the inner bearing elements and the outer bearing elements,
wherein
the inner bearing elements are formed of a one-piece inner bearing sleeve which is releasably attached to the carrier sleeve and carries the drive element.

2. A handpiece according to claim 1,
wherein
the inner bearing sleeve sits on the carrier sleeve with matching surfaces arranged at least in the end regions of the inner bearing sleeve.

3. A handpiece according to claim 1,
wherein
the inner bearing sleeve and the drive element form a pre-mounted bearing unit.

4. A handpiece according to claim 3,
wherein
the inner bearing sleeve and the drive element are balanced before their assembly to the bearing unit or the pre-mounted bearing unit is balanced in common with the inner bearing sleeve and the drive element.

5. A handpiece according to claim 1,
wherein
the carrier sleeve has a radially projecting shoulder, on which the inner bearing sleeve bears.

6. A handpiece according to claim 5,
wherein
the radially projecting shoulder is formed by a flange on the carrier sleeve, the flange is preferably arranged at an end of the carrier sleeve which is away from the side from which the tool is insertable.

7. A handpiece according to claim 1,
wherein
the carrier sleeve and the mounting sleeve form a pre-mounted mounting-unit.

8. A handpiece according to claim 7,
wherein
the carrier sleeve and the mounting sleeve are balanced before their assembly to the mounting unit or the pre-mounted mounting unit is balanced in common with the carrier sleeve and the mounting sleeve.

9. A handpiece according to claim 1,
wherein
the connection between the inner bearing sleeve and the drive element and/or the carrier sleeve is one of a press-fit connection and an adhesive connection.

10. A handpiece according to claim 1,
wherein
the connection between the carrier sleeve and the mounting sleeve is one of a press-fit connection and an adhesive connection.

11. A handpiece according to claim 1,
wherein
the inner bearing elements are formed on the inner bearing sleeve by a running groove, which is outwardly open, axially on the outside, for an introduction of the roller bodies held by a cage and the associated outer ring.

12. A handpiece according to claim 1,
wherein
the outer bearing elements are formed by running grooves in outer rings of roller bearings, wherein the running grooves are axially open on one side for the pushing on of the associated outer ring.

13. A handpiece according to claim 11,
wherein
there is arranged at the open side of the running groove in each case a radial elevation which applies to the roller bodies an axial resistance which can be overcome by an axial force.

14. A handpiece according to claim 1,
wherein
neighboring the open side of the running groove there is arranged a lead-in surface which is divergent step-like or continuously towards the associated running groove or elevation.

15. A handpiece according to claim 13,
wherein
the elevation is formed by remaining material upon material removing working.

16. A handpiece according to claim 1,
wherein
the drive element is one of a turbine wheel and a gear (pinion).
